(19) United States
(12) Patent Application Publication
(10) Pub. No.: US 2017/0352073 A1
(43) Pub. Date: Dec. 7, 2017

(54) PLATFORM CONFIGURATION TOOL

(71) Applicant: Accenture Global Solutions Limited, Dublin (IE)

(72) Inventors: Sidramesh Shivabasappa Musti, Bangalore (IN); Priyanka Menon, Ernakulam (IN); Nithin Ravani Nanjundaswamy, Bangalore (IN); Nikita Garg, Lucknow (IN); Deepika Gajulapalli, Bangalore (IN)

(21) Appl. No.: 15/609,436

(22) Filed: May 31, 2017

(30) Foreign Application Priority Data
Jun. 2, 2016 (IN) 201641018933

(51) Int. Cl. G06Q 30/04

(52) U.S. Cl. CPC G06Q 30/04

(57) ABSTRACT

Implementations include receiving user input to a computer-implemented platform configuration tool, the user input defining a release that is to be processed and automatically deployed to at least one computer-implemented billing systems by the computer-implemented configuration tool, the release identifying at least one change request; receiving user input to the computer-implemented platform configuration tool, the user input identifying the at least one computer-implemented billing system, to which the release is to be applied; automatically: staging the release, testing the release as applied to the at least one computer-implemented billing system in a testing environment, and providing results based on testing; and receiving user input to the computer-implemented platform configuration tool, the user input approving the results, and in response, automatically deploying the release to the at least one computer-implemented billing system in a production environment.

### CROSS-REFERENCE TO RELATED APPLICATION

This application claims priority to Indian Provisional Patent Application No. 201641018933, filed on Jun. 2, 2016, entitled “PLATFORM CONFIGURATION TOOL,” the entirety of which is hereby incorporated by reference.

### BACKGROUND

Enterprises use computer-implemented platforms to perform enterprise operations. In some examples, the platforms include multiple sub-platforms to address customizations. For example, enterprises can use a computer-implemented billing platform to bill customers for services provided by the enterprise. The billing platform can include multiple billing systems that (e.g., sub-platforms) that can be based on region, product, customer-segment, and the like. Accordingly, each billing system in the platform can be considered customized, requiring its own application-specific configuration.

Revisions, even minor revisions, to a platform can result in configurations that need to be propagated to all sub-platforms. This can require parallel configuration processes (e.g., a configuration process for each sub-platform) to be performed to adopt the revisions across the platform. Such parallel configuration processes, however, expend resources and require time to bring the revised platform online. Not only are human resources expended, the parallel configuration processes drain technical resources (e.g., processors, memory, bandwidth).

### SUMMARY

Implementations of the present disclosure are generally directed to a platform configuration tool for configuring a plurality of computer-implemented platforms. In some implementations, actions include receiving user input to a computer-implemented platform configuration tool, the user input defining a release that is to be processed and automatically deployed to at least one computer-implemented billing systems by the computer-implemented configuration tool, the release identifying at least one change request; receiving user input to the computer-implemented platform configuration tool, the user input identifying the at least one computer-implemented billing system, to which the release is to be applied; automatically: staging the release, testing the release as applied to the at least one computer-implemented billing system in a testing environment, and providing results based on testing; and receiving user input to the computer-implemented platform configuration tool, the user input approving the results, and in response, automatically deploying the release to the at least one computer-implemented billing system in a production environment. Other implementations of this aspect include corresponding systems, apparatus, and computer programs, configured to perform the actions of the methods, encoded on computer storage devices.

These and other implementations can each optionally include one or more of the following features: the release is selected from a list of available releases; the change request is provided based on one of a bulk upload and a manual upload; staging the release comprises storing release data in a common product model format; and the release comprises at least on change request that is to be applied to the at least one computer-implemented billing system

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system that can execute implementations of the present disclosure.

FIG. 2 depicts an example module architecture in accordance with implementations of the present disclosure.

FIG. 3 depicts an example process that can be executed in implementations of the present disclosure.

### DETAILED DESCRIPTION

Implementations of the present disclosure are generally directed to a platform configuration tool for configuring a plurality of computer-implemented platforms. More particularly, implementations of the present disclosure are directed to automatically publishing a release that includes one or more change requests to at least one computer-implemented platform of a plurality of computer-implemented platforms. Implementations include receiving user input to a computer-implemented platform configuration tool, the user input defining a release that is to be processed and automatically deployed to at least one computer-implemented billing systems by the computer-implemented configuration tool, the change request identifying a release; receiving user input to the computer-implemented platform configuration tool, the user input identifying the at least one computer-implemented billing system, to which the release is to be applied; automatically: staging the release, testing the release as applied to the at least one computer-implemented billing system in a testing environment, and providing results based on testing; and receiving user input to the computer-implemented platform configuration tool, the user input approving the results, and in response, automatically deploying the release to the at least one computer-implemented billing system in a production environment.

Implementations of the present disclosure will be described in further detail herein with reference to an example context. The example context includes a computer-implemented billing platform that is used by an enterprise to bill users for services provided by the enterprise. An example billing platform (also referred to herein as billing system) includes the Kill Bill open source billing platform (http://killbill.io/). The example context further includes a computer-implemented billing platform that is used by a telecom provider to bill users for telecom services. In the example context, a product includes a saleable entity (e.g., item, service), a tariff includes a set of rules, methods, rates for charging users for the product, and a service is a service delivered by the telecom provider to the user as part of the product. Although an example context is used to illustrate implementations described herein, it is contemplated the implementations of the present disclosure can be realized in any appropriate context.

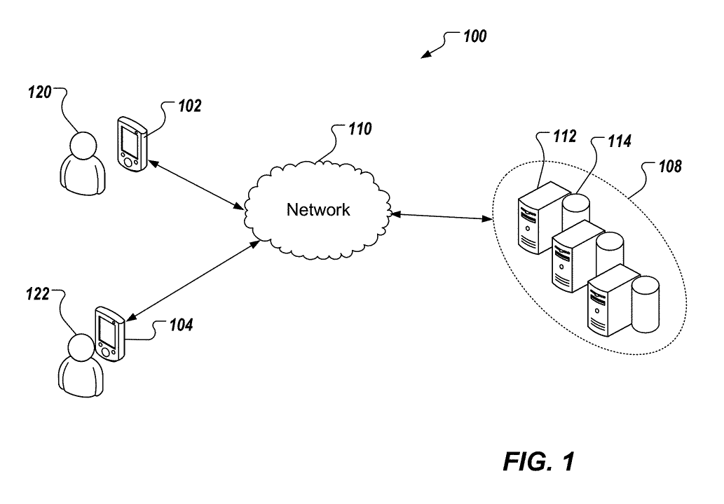

FIG. 1 depicts an example system 100 that can execute implementations of the present disclosure. The example system 100 includes computing devices 102, 104, a back-end system 108, and a network 110. In some examples, the network 110 includes a local area network (LAN), wide area network (WAN), the Internet, or a combination thereof, and connects web sites, devices (e.g., the computing device 102, 104), and back-end systems (e.g., the back-end system 108). In some examples, the network 110 can be accessed over a wired and/or a wireless communications link. For example, mobile computing devices, such as smartphones can utilize a cellular network to access the network 110.

In the depicted example, the back-end system 108 includes at least one server system 112, and data store 114 (e.g., database and knowledge graph structure). In some examples, the at least one server system 112 hosts one or more computer-implemented services that users can interact with using computing devices. For example, the server system 112 can host computer-implemented a computer-implemented platform related to services provided by an enterprise. In the example context, the server system 112 hosts a computer-implemented billing platform that is used by a telecom provider to bill users for telecom services

In some examples, the computing devices 102, 104 can each include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In general, and in accordance with the example context, the computing devices 102, 104 include any appropriate type of computing device that enables respective users 120, 122 to consume services provided by the telecom provider. For example, each of the computing devices 102, 104 can include smartphones that enables the users 120, 122 to consume services (e.g., call, text, Internet) provided by the telecom provider. In some examples, the users 120, 122 can be in different locales. For example, the users 120, 122 can be in different countries, or different states/provinces/regions within the same country.

In the example context, telecom service providers face challenges with multiple computer-implemented billing systems that are based on regions, products, and/or customer types (e.g., commercial, residential). In some examples, the configurations of the respective billing systems have to be managed, which requires skilled personnel and technical resources (e.g., processors, memory, bandwidth). For example, frequent configuration changes, which is an industry norm, can require a relatively slow, monotonous process to propagate to multiple billing systems, and can be a drain on technical resources.

To better highlight these issues, an example software development lifecycle (SDL), which is used to build, test, and deploy billing systems, will be described. In general, the example SDL includes a requirements stage, a requirements analysis stage, a build and test stage, and a deploy stage. Requirements that the billing systems to meet are defined (requirements stage), and are analyzed for conformance with the enterprise's needs (requirements analysis stage). In view of the disparity of requirements for particular billing systems, the requirements include multiple, application-specific requirements, which are provided to respective development teams, which build, test, and deploy the respective billing systems. The multiple development teams can use various, disparate development tools, and independently develop solutions for the respective billing system they are tasked with. Accordingly, upon deployment, an enterprise can be relying on multiple, independently developed billing systems that are based on a common set of requirements. If, however, a requirement changes, and revisions are to be propagated across billing systems, because each billing system was uniquely developed, propagation of revisions will be application-specific.

To address these issues, implementations of the present disclosure provide a platform configuration tool that is platform-agnostic, industry-agnostic, and can be used across multiple applications (e.g., billing systems). As described herein, the platform configuration tool of the present disclosure supports multiple applications and provides a standard and automated process for configuration of the multiple applications. The platform configuration tool of the present disclosure enables new and/or modified elementary configurations to be provided without the need for tool knowledge, and enables conversion of configurations for different applications from a common platform. Implementations also provide a more controlled and automated ability to build, test, and publish components to different applications and to multiple instances of the application. Further, implementations of the present disclosure reduce the time to market, improve accuracy levels and reduce development cost, and can be applied and re-used for new engagements.

In general, and as described in further detail herein, the platform configuration tool of the present disclosure includes a test engine, a configuration engine, and a transformation and synchronization engine (e.g., each provided as one or more computer-executable modules, described in further detail herein). The following example terms are provided, and are used herein: release→a collection of change requests that is deployed in a single cycle; change request→a single business request (e.g., change in product offering); and test manager→an automated test engine. The platform configurations tool implements a configuration process that includes the following example workflow: input→stage→validation→transformation→test→approve→deploy. Input includes inputting release data. Stage includes staging the data in a staging environment. Validation includes validating the data based on a set of rules. Transformation includes transforming the data to an application-specific model. Test includes automatic testing. Approve includes receiving approval that the test results are valid. Deploy indicates deploying the updated applications to production environments.

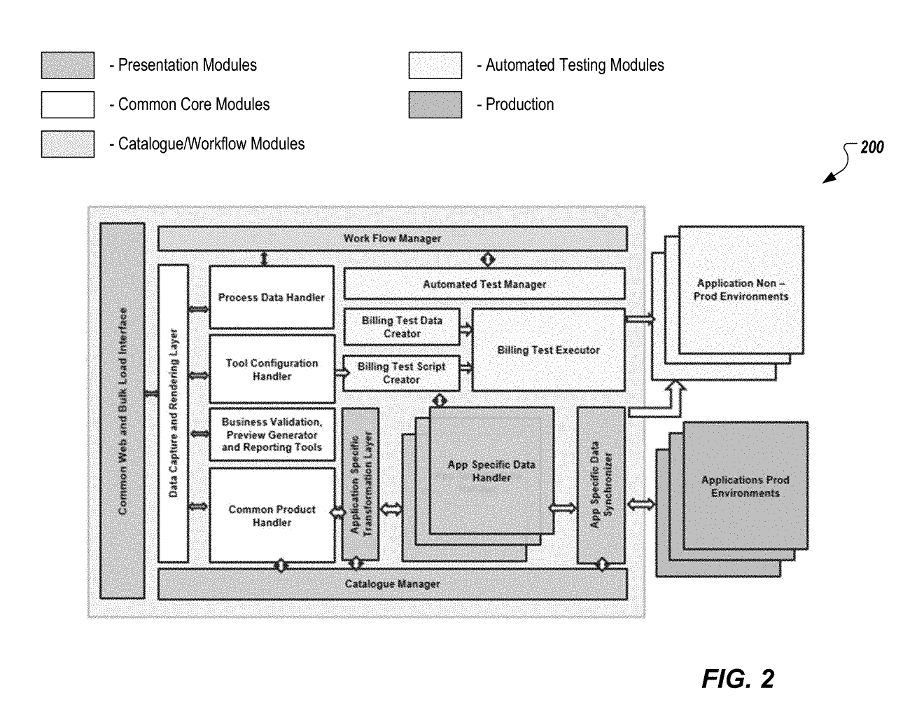

FIG. 2 depicts an example module architecture 200 in accordance with implementations of the present disclosure. In the depicted example, the module architecture 200 includes presentation modules, common core modules, catalogue/workflow modules, automated testing modules, and a production environment.

In some implementations, the presentation modules include one or more modules that provide a front-end, through which users can interact with the platform configuration tool. In some examples, the presentation modules provide a web portal (e.g., graphical user interface (GUI)) and bulk upload interface, through which a user can submit configuration requirements into the platform configuration tool and/or make updates. In some implementations, the user can upload requirements in bulk through pre-defined templates (e.g., MS Excel templates). In some examples, the user is able to approve checkpoints.

In some implementations, the common core modules include a data capture and rendering module, a process data handler module, a tool configuration handler module, a business validation, preview generator, and reporting module, and a common product handler module. In some examples, the common core modules contains data stores for staging common product configuration data, tool metadata configuration, validation rules and process data, and contains tools and methods for business validation, data rendering and reporting.

In some implementations, the catalogue and workflow modules include a workflow manager module, a catalogue manager module, an application-specific transformation module, one or more application-specific data handler modules, and an application-specific data synchronizer module. In some examples, the catalogue manager module is a controllers that maintains changes for specific applications in a catalogue, ensures multi-application and multiple iteration delivery, and maintains all application-specific configuration data. In some examples, the application-specific data synchronizer synchronizes configuration data from the application production environments and enable synchronization with non-production environments (e.g., test environments), and enables deployment and rollback changes into the non-production and production environments. In some examples, the application-specific transformation module transforms configuration data from an application-specific data model to a common product model, and vice-versa. In some examples, the workflow manager module operates as a release manager and orchestrates tasks executed during a development life cycle (DLC). In some examples, the workflow manager module ensure entry and exit criteria are met before triggering tasks, schedules different tasks required for each DLC.

In some implementations, the automated testing modules control automated testing tasks, identify changes made on the catalogue and identifies test cases that are to be created. In some examples, the automated testing modules create billing test data and test scripts, as well as create test accounts and test usage records for testing. In some examples, the automated testing modules remotely trigger billing processes on the non-production environments to test the new/updated configuration(s). In some examples, the automated testing modules generate a bill and compares the results with the expected results. That is, the automated testing module compares test results to expected results to determine whether the configuration(s) performed as expected. In some examples, test results can be approved, such that the configuration(s) can be automatically deployed to the application production environments through the catalogue/workflow modules.

In some implementations, the platform configuration tool provides a plurality of graphical user interfaces (GUIs), through which a user (e.g., administrator) can interact with the platform configuration tool and effect a release to one or more applications. For example, a log-in GUI can be provided, through which the user provides credential to log-into (be authenticated by) the platform configuration tool. As another example, a series of release GUIs can be provided, through which the user can create, edit, and/or check on the status of a release. As another example, a series of change request GUIs can be provided, through which the user can add and/or update change requests.

In some implementations, the user can create a release using a release GUI. In some examples, the user selects a particular application (billing system), to which the to-be-created release is to be deployed. In some examples, the application can be selected from a drop-down menu of production applications (e.g., applications currently used to process billing for users). In some examples, the user can provide a description of the release, can indicate the production date for the release, can select a test environment, in which the release is to be tested (e.g., from a list of available test environments), and/or can indicate the production environment for the release. In some examples, the user can click on a “Create Release” button to create the release based on the information that the user has input. In some examples, in response to the user creating the release, a release identifier is assigned to the release, and the release is processed through the workflow (e.g., is staged for subsequent testing).

To deploy the release to the application, the user creates a change request using the platform configuration tool. In some implementations, the user creates a change request by selecting a release from a list of available releases, and provides change request details. For example, the user can input a change request number and a change request description. In some examples, the user can click on as “Add Change Request” button to create the change request based on the information that the user has input.

In some implementations, in response to the user creating the change request, the user is requested to identify which application (e.g., billing system) the change request is to be applied to, select an input type for the change request, and select an input file. With respect to input type, a change request can be implemented using either a bulk upload, or a manual upload. In some examples, a bulk upload uses a predefined template that includes requirements fields, and users can input values into the requirements fields. In some examples, a manual upload provides a GUI that enables users to input requirements.

In some implementations, if the user selects a manual upload, a product details GUI is provided, through which the user is able to create a product. In some examples, the product details GUI enables the user to input values for a plurality of attributes of the to-be-created product. Example attributes include product name, product description, product family, product class, customer segment, product type, realm, product start date, product end date, and product status. In some examples, respective values of one or more attributes can be selected from a list of available values. In some examples, the platform configuration tool automatically displays which attributes require values to be input based on underlying requirements of the selected application (e.g., billing system). In some examples, the user can click on an “Add Product” button to create the product based on the information that the user has input.

In some implementations, the user can create a tariff for a product using a tariff details GUI. In some examples, the tariff details GUI enables the user to input values for a plurality of attributes of the to-be-created tariff. Example attributes include tariff name, tariff description, tariff type (e.g., non-recurring, recurring, standard, discount, and termination), tariff start date, tariff end date, application context, periodicity, currency, tax inclusive, billable, bill context, invoice section, invoice text, charge category, invoicing company, and invoice region. In some examples, the user selects the type of tariff, and respective default values are automatically input for one or more attributes. In some examples, the user can input their own values for attributes, and/or edit the default values. In some examples, the user can click on an “Add Tariff” button to create the product based on the information that the user has input.

In some implementations, a tariff can be associated with a product, a service can be associated with a product, and/or a product can be associated with a product. In some examples, a tariff-product association GUI is provided, through which the user can associate a product with a tariff. In some examples, the user input the product name and the tariff name, as well as values for one or more attributes. Example attributes include initiation tariff, initiation amount, whether the initiation tariff is optional, standard tariff, standard amount, whether the standard tariff is optional, recurring tariff, recurring amount, whether the recurring tariff is optional, cancellation tariff, cancellation amount, whether the cancellation tariff is optional, start date, and end date. In some examples, default values for one or more attributes are provided based on the user-input tariff name. In some examples, the user can input their own values for attributes, and/or edit the default values. In some examples, the user can click on an “Associate Tariff” button to create the association between the product and the tariff based on the information that the user has input.

In some implementations, the user can review a status of a release using a release GUI. For example, the user can select a release from a list of releases (e.g., provided in a drop-down menu), and in response, a status of the selected release is provided. In some examples, the status includes values for release identifier, release description, environment, synchronization status (e.g., synced), synchronization date, release status (e.g., staged), and release date. In some examples, staged is one of a plurality of states of the release, and indicates a state, in which release data is saved in a common product model format. In some examples, after the release is tested, and approved, the release is deployed, which includes publishing the configuration across the billing system(s).

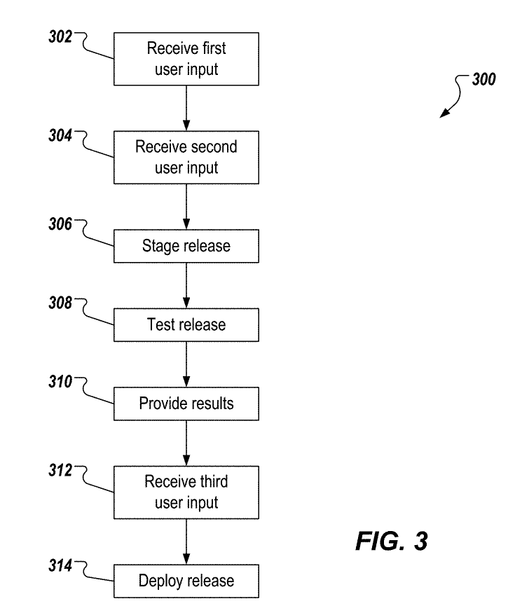

FIG. 3 depicts an example process 300 that can be executed in implementations of the present disclosure. In some examples, the example process 300 is provided using one or more computer-executable programs executed by one or more computing devices (e.g., the back-end system 108 of FIG. 1). The example process 300 can be executed to configure a platform in accordance with implementations of the present disclosure.

First user input is received (302). For example, the first user input is received by a computer-implemented platform configuration tool, the first user input defining a release that is to be processed and automatically deployed to at least one computer-implemented billing system by the computer-implemented configuration tool, the release identifying one or more change requests. Second user input is received (304). For example, the second user input is received by the computer-implemented platform configuration tool, the second user input identifying the at least one computer-implemented billing system, to which the release is to be applied.

The computer-implemented platform configuration tool automatically: stages the release (306), tests the release as applied to the at least one computer-implemented billing system in a testing environment (308), and provides results based on testing (310). Third user input is received (312). For example, the third user input is received by the computer-implemented platform configuration tool, the third user input approving the results. In response to the third user input, the computer-implemented platform configuration tool automatically deploys the release to the at least one computer-implemented billing system in a production environment (314).

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical user interface or a Web browser through which a user may interact with an implementation, or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for configuring a plurality of computer-implemented billing systems, the method being executed by one or more processors and comprising:
receiving, by the one or more processors, user input to a computer-implemented platform configuration tool, the user input defining a release that is to be processed and automatically deployed to at least one computer-implemented billing systems by the computer-implemented configuration tool, the release identifying at least one change request;
receiving, by the one or more processors, user input to the computer-implemented platform configuration tool, the user input identifying the at least one computer-implemented billing system, to which the release is to be applied;
automatically, by the one or more processors:
staging the release,
testing the release as applied to the at least one computer-implemented billing system in a testing environment, and
providing results based on testing; and
receiving, by the one or more processors, user input to the computer-implemented platform configuration tool, the user input approving the results, and in response, automatically, by the one or more processors, deploying the release to the at least one computer-implemented billing system in a production environment.

2. The method of claim 1, wherein the release is selected from a list of available releases.

3. The method of claim 1, wherein the change request is provided based on one of a bulk upload and a manual upload.

4. The method of claim 1, wherein staging the release comprises storing release data in a common product model format.

5. The method of claim 1, wherein the release comprises at least on change request that is to be applied to the at least one computer-implemented billing system.

6. One or more non-transitory computer-readable storage media coupled to one or more processors and having instructions stored thereon which, when executed by the one or more processors, cause the one or more processors to perform operations for configuring a plurality of computer-implemented billing systems, the operations comprising:
receiving, by the one or more processors, user input to a computer-implemented platform configuration tool, the user input defining a release that is to be processed and automatically deployed to at least one computer-implemented billing systems by the computer-implemented configuration tool, the release identifying at least one change request;
receiving, by the one or more processors, user input to the computer-implemented platform configuration tool, the user input identifying the at least one computer-implemented billing system, to which the release is to be applied;
automatically, by the one or more processors:
staging the release,
testing the release as applied to the at least one computer-implemented billing system in a testing environment, and
providing results based on testing; and
receiving, by the one or more processors, user input to the computer-implemented platform configuration tool, the user input approving the results, and in response, automatically, by the one or more processors, deploying the release to the at least one computer-implemented billing system in a production environment.

7. The computer-readable storage media of claim 6, wherein the release is selected from a list of available releases.

8. The computer-readable storage media of claim 6, wherein the change request is provided based on one of a bulk upload and a manual upload.

9. The computer-readable storage media of claim 6, wherein staging the release comprises storing release data in a common product model format.

10. The computer-readable storage media of claim 6, wherein the release comprises at least on change request that is to be applied to the at least one computer-implemented billing system.

11. A system, comprising:
one or more processors; and
a computer-readable storage device coupled to the one or more processors and having instructions stored thereon which, when executed by the one or more processors, cause the one or more processors to perform operations for configuring a plurality of computer-implemented systems, the operations comprising:
receiving, by the one or more processors, user input to a computer-implemented platform configuration tool, the user input defining a release that is to be processed and automatically deployed to at least one computer-implemented billing systems by the computer-implemented configuration tool, the release identifying at least one change request;
receiving, by the one or more processors, user input to the computer-implemented platform configuration tool, the user input identifying the at least one computer-implemented billing system, to which the release is to be applied;
automatically, by the one or more processors:
staging the release,
testing the release as applied to the at least one computer-implemented billing system in a testing environment, and
providing results based on testing; and
receiving, by the one or more processors, user input to the computer-implemented platform configuration tool, the user input approving the results, and in response, automatically, by the one or more processors, deploying the release to the at least one computer-implemented billing system in a production environment.

12. The system of claim 11, wherein the release is selected from a list of available releases.

13. The system of claim 11, wherein the change request is provided based on one of a bulk upload and a manual upload.

14. The system of claim 11, wherein staging the release comprises storing release data in a common product model format.

15. The system of claim 11, wherein the release comprises at least on change request that is to be applied to the at least one computer-implemented billing system.
